(19) United States
(12) Patent Application Publication
(10) Pub. No.: US 2006/0115337 A1
(43) Pub. Date: Jun. 1, 2006

(54) Runout eliminating collet chuck

(76) Inventor: Fusao Higashi, Irvine, CA (US)

Correspondence Address: BRUCE A. JAGGER, 6100 CENTER DRIVE, SUITE 630, LOS ANGELES, CA, 90045, US

(21) Appl. No.: 11/001,987

(22) Filed: Dec. 1, 2004

(51) Int. Cl. B23B 31/20

(52) U.S. Cl. 408/181

(57) ABSTRACT

A precision collet chuck assembly of the type where the shank of a tool is mounted in a bore in a split collet and a clamping nut squeezes the split collar into a gripping association with the shank of the tool. At least three radially adjustable set screws are positioned so as to bear against a rotating tool at a location axially beyond the collet and between the tip of the tool and the shank of the tool. These set screws are individually and selectively adjustable to bring the tip of the tool into a desired position relative to the axis of rotation of the assembly. The extent of the adjustment is generally limited to less than about 0.002 inches. The radially adjustable set screws can be mounted in a centering collar portion of the clamping nut or in a separate centering collar. The adjusting set screws can be mounted with their longitudinal axes defining a common plane or one or more cones with the tips of the cones on the rotational axis of the assembly. Being in direct engagement with the tool causes the adjusting set screws to be exposed to considerable shock and vibration. This may cause them to move out of radial adjustment. Locking set screws are provided for locking engagement with the adjusting set screws to hold the adjusting set screws in the desired radial positions.

### BACKGROUND OF THE INVENTION

1. Field of the Invention

The invention relates in general to methods and devices for eliminating runout for tools mounted in collet chucks. More particularly, embodiments of the present invention relate to eliminating runout in conventional collet chucks wherein adjustments to the concentricity of tools are applied directly to the tool.

2. Description of the Prior Art

The term “runout” as used in the machine tool arts typically refers to the fact that rotating tools such as drill bits, reamers, end mills, or the like, often do not rotate exactly about their longitudinal axes. That is, the axis of rotation of the tool is not concentric with the longitudinal axis of the tool, at least at the location where the tool engages a workpiece. The cutting tip of the rotating tool, for example, describes a circle rather than a single point because the tool is not centered in its holder (lateral offset), or is mounted in the holder at an angle to the rotational axis of the system, or suffers from some combination of these conditions. This results in inaccurately formed workpieces, and possible damage to the tool or machine. Many prior expedients had been proposed for the purpose of minimizing or eliminating runout. The prior art devices and methods are not without their shortcomings. A major shortcoming of typical prior art devices and methods is their complexity in both construction and use. Further, such prior expedients did not apply adjustments to the concentricity of the mounting of a tool directly to the tool itself. For example, Priessnitz U.S. Pat. No. 4,930,957 proposes to center a tool restrained within a collet by forming the driver for the holder of the collet so that it can be deflected by adjustment screws mounted in the driver. This is problematic for a number of reasons. This distortion of the driver deflects the holder for the collet, the collet itself, and the tool that is chucked in the collet. While the tip of the cutting tool may be rotating about a single point after the adjustment is made, the rest of the rotating mass is frequently not rotating concentrically with the longitudinal axis of the system. At higher speeds there is enough unbalanced rotating mass to generate substantial vibration. Such modifications to the driver are expensive, require precise modifications, and tend to weaken it. If more than four adjustment screws are required, they would be difficult or impossible to provide. Some proposed prior expedients required that a skilled machinist first correct the angular misalignment of the tool and then the lateral offset of the tool. This takes time and requires considerable skill and experience. Many prior proposed expedients were subject to rapid wear or were easily damaged.

Prior expedients for aligning tools that are not mounted in collets include, for example, Micek U.S. Pat. No. 4,666,353 (adjusting the driver to which a holder for a tool is mounted); Jacobson U.S. Pat. No. 4,930,947 (a tool holder wherein a tool is secured in a bore by a radially mounted set screw, and the tool is purportedly centered to the tool holder by a pair of alignment members that extend tangentially of the bore); McGill U.S. Pat. No. 4,326,361 (an adjustable hub mount for a circular saw blade where four adjustment screws cause the hub to be mis-aligned to compensate for lateral warpage of the saw blade); Stelmachowski U.S. Pat. No. 2,841,929 (Uses circumferentially spaced set screws acting radially on the hub for a diamond grinding wheel to shift the hub and wheel radially of the axis of rotation to bring the axis of rotation of the system into congruency with the axis of the wheel); and Hoffman U.S. Pat. No. 4,265,057 (a shaft to which a chuck for a gem stone is mounted is inserted into a tubular dop arm and aligned with the axis of the dop arm by two sets of four screws each where the sets of screws are axially spaced along tubular dop arm). The assembly of Hoffman is only rotated in small precise angular increments to accomplish the cutting of facets on a gem stone. The assembly holds the workpiece rather than the tool. A lath dog in the form of a stepped cylindrical sleeve that is fastened to both a tool and a tool holder was proposed by Ingram U.S. Pat. No. 3,691,883. The set screws that secure the assembly together are not positioned so as to accomplish precision alignment of the cutting tool. The purpose is to prevent rotation of the tool in the holder, not to accomplish precision alignment of the tool.

Those concerned with these problems recognize the need for an improved precision tool alignment assembly, particularly where the runout is in the range of about b 0.002 inches or less, and a collet chuck assembly is employed.

### BRIEF SUMMARY OF THE INVENTION

The present invention has been developed in response to the current state of the art, and in particular, in response to these and other problems and needs that have not been fully or completely solved by currently available expedients. Thus, it is an overall object of the present invention to effectively resolve at least the problems and shortcomings identified herein. In particular, it is an object of the present invention to provide a simple, rugged precision alignment assembly for rotating tools wherein an aligning force is applied directly to a tool mounted in a collet chuck. It is also an object of the present invention to provide according to one embodiment an alignment assembly that can be mounted to a conventional collet chuck assembly without modifying the conventional collet chuck assembly. Finally, it is an object of the present invention to provide an alignment assembly that can be used by relatively unskilled workers to quickly adjust at least the alignment of the tip of a rotating cutting tool to be congruent or in a predetermined relationship with the rotational axis of the system. Embodiments of the present invention are particularly suitable for correcting small radial excursions (less than about 0.002 inches) of the tip of a rotating cutting tool

A preferred embodiment of the precision alignment assembly according to the present invention comprises a collet chuck assembly that includes a conventional collet member and a clamping nut element. The clamping nut element is threadably mounted to a conventional tool holder. When the clamping nut is tightened it squeezes the collet member radially inwardly to grip a shank of a tool that is received axially in the collet member. The collet chuck assembly has an axis of rotation about which it rotates. The tool has a longitudinal axis and a tip. The tool projects axially from the axially outer end of the collet, and the tip is axially remote from the shank.

A precision collet chuck assembly according to the present invention includes at least three generally radially adjustable elements spaced generally circumferentially from one another around the axis of rotation of the assembly. These radially adjustable elements are positioned to bear directly on the tool generally along radii of the tool or the assembly. Tools frequently have generally cylindrical forms, however, other cross-sectional forms such as square, hexagonal, or the like are sometimes used. Regardless of the cross-sectional shape of the tool, it generally has a longitudinal axis. The radially adjustable elements apply force generally along radii of the tool relative to the axis of rotation of the system. The location of the tool tip is adjusted relative to the axis of rotation of the system by adjustment of the adjustable elements. These radially adjustable elements are in adjustably engaging relationship with the tool at a location between the tool shank in the collet member and the tip.

The generally radially adjustable elements are preferably threadably mounted for ease of radial adjustment. These elements can be mounted, for example, in the clamping nut element, or in a centering collar member. The centering collar member is preferably mounted at least in part to the clamping nut element. One form of centering collar is a centering bonnet that slips over and clamps to a conventional clamping nut element. In general, at least three radially adjustable elements are provided. More radially adjustable elements can be employed, if desired. Four, five, six, or more such elements can be employed.

The generally radially adjustable elements function by deflecting the tool to bring the longitudinal axis of the tool into a desired alignment with the axis of rotation of the system, at least at approximately the tip of the tool. Usually, the objective is to bring the tip of the tool into alignment with the rotational axis of the system so that the tip rotates about a single point rather than defining a circle as it rotates. In some circumstances, it is desirable that the tool tip describe such a circle. The present invention is adapted to adjusting the tool to obtain either objective.

The generally radially adjustable elements bear directly on the tool at a location between the shank in the collet member and the tip of the tool, and are subject to considerable shock and vibration. Preferably, these elements are positioned radially to bring the tool into the desired alignment with the rotational axis of the system and then locked into these desired radial positions. To this end, locking members are provided in locking association with these radially adjustable elements. In one embodiment these locking members take the form of set screws that laterally engage, through protective pads, the radially adjustable elements.

To acquaint persons skilled in the pertinent arts most closely related to the present invention, a preferred embodiment of a precision alignment assembly that illustrates a best mode now contemplated for putting the invention into practice is described herein by, and with reference to, the annexed drawings that form a part of the specification. The exemplary precision alignment assembly is described in detail without attempting to show all of the various forms and modifications in which the invention might be embodied. As such, the embodiments shown and described herein are illustrative, and as will become apparent to those skilled in the arts, can be modified in numerous ways within the scope and spirit of the invention, the invention being measured by the appended claims and not by the details of the specification or drawings.

Other objects, advantages, and novel features of the present invention will become more fully apparent from the following detailed description of the invention when considered in conjunction with the accompanying drawings, or may be learned by the practice of the invention as set forth herein.

### BRIEF DESCRIPTION OF THE DRAWINGS

The present invention provides its benefits across a broad spectrum of machining operations. While the description which follows hereinafter is meant to be representative of a number of such applications, it is not exhaustive. As those skilled in the art will recognize, the basic apparatus taught herein can be readily adapted to many uses. This specification and the claims appended hereto should be accorded a breadth in keeping with the scope and spirit of the invention being disclosed despite what might appear to be limiting language imposed by the requirements of referring to the specific examples disclosed.

Referring particularly to the drawings for the purposes of illustrating the invention and its presently understood best mode only and not limitation:

FIG. 1 is a top view of a prior art collet and clamping nut in a collet chuck assembly.

FIG. 2 is a side view of the prior art collet shown in FIG. 1.

FIG. 3 is a side view of the prior art clamping nut shown in FIG. 1.

FIG. 4 is a cross-sectional side view of the prior art collet chuck assembly taken along line 4-4 in FIG. 1.

FIG. 5 is a side view of a clamping nut according to the present invention.

FIG. 6 is a top view of the clamping nut of FIG. 5 assembled with the collet of FIG. 2.

FIG. 7 is a cross-sectional side view of the collet chuck assembly taken along line 7-7 in FIG. 6.

FIG. 8 is a cross-sectional view similar to FIG. 7 except that a locking set screw is provided to hold a radially adjustable set screw in a predetermined radial position.

FIG. 9 is a view of the collet chuck assembly of FIG. 4 including a centering bonnet according to the present invention mounted thereon.

FIG. 10 is a diagrammatic side view of a rotatable cutting tool.

FIG. 11 is a diagrammatic side view of the collet of FIG. 2.

FIG. 12 is a diagrammatic side view of the rotatable cutting tool of FIG. 10 mounted in the collet of FIG. 11 with the longitudinal axis of the cutting tool perfectly aligned with the rotational axis of the assembly.

FIG. 13 is a diagrammatic partial side view of the rotatable cutting tool of FIG. 10 in a configuration where the axis of rotation of the assembly is parallel to but laterally offset from the longitudinal axis of the cutting tool so that the tip of the cutting tool describes a circle as it rotates.

FIG. 14 is a diagrammatic partial side view of the rotatable cutting tool of FIG. 10 in a configuration where the axis of rotation of the assembly is angularly misaligned with the longitudinal axis of the cutting tool so that the tip of the cutting tool describes a circle as it rotates.

FIG. 15 is a broken diagrammatic side view of a collet with a tool shank mounted in its central bore, and with the longitudinal axes of radially adjustable centering elements indicated extending at an angle into contact with the tool at an adjusting circle located axially outwardly of the shank of the tool.

FIG. 16 is a diagrammatic end view of a collet with a tool mounted in its axial bore, and with the longitudinal axes of radially adjustable centering elements indicated extending into generally tangential contact with the tool.

FIG. 17 is a cross-sectional side view of the collet chuck assembly similar to FIG. 7 and is illustrative of those embodiments where the radially adjustable elements are in more than one piece.

FIG. 18 is a cross-sectional side view of the collet chuck assembly similar to FIG. 17 and is illustrative of a further embodiment wherein the radially adjustable elements are in more than one piece.

FIG. 19 is a cross-sectional side view of the collet chuck assembly of FIG. 18 wherein the radially adjustable elements and a tool are both illustrated.

### DETAILED DESCRIPTION OF THE PREFERRED EMBODIMENTS

Referring now to the drawings wherein, like reference numerals designate identical or corresponding parts throughout the several views. It is to be understood that the drawings are diagrammatic and schematic representations of various embodiments of the invention, and are not to be construed as limiting the invention in any way. The use of words and phrases herein with reference to specific embodiments is not intended to limit the meanings of such words and phrases to those specific embodiments. Words and phrases herein are intended to have their ordinary meanings, unless a specific definition is set forth at length herein.

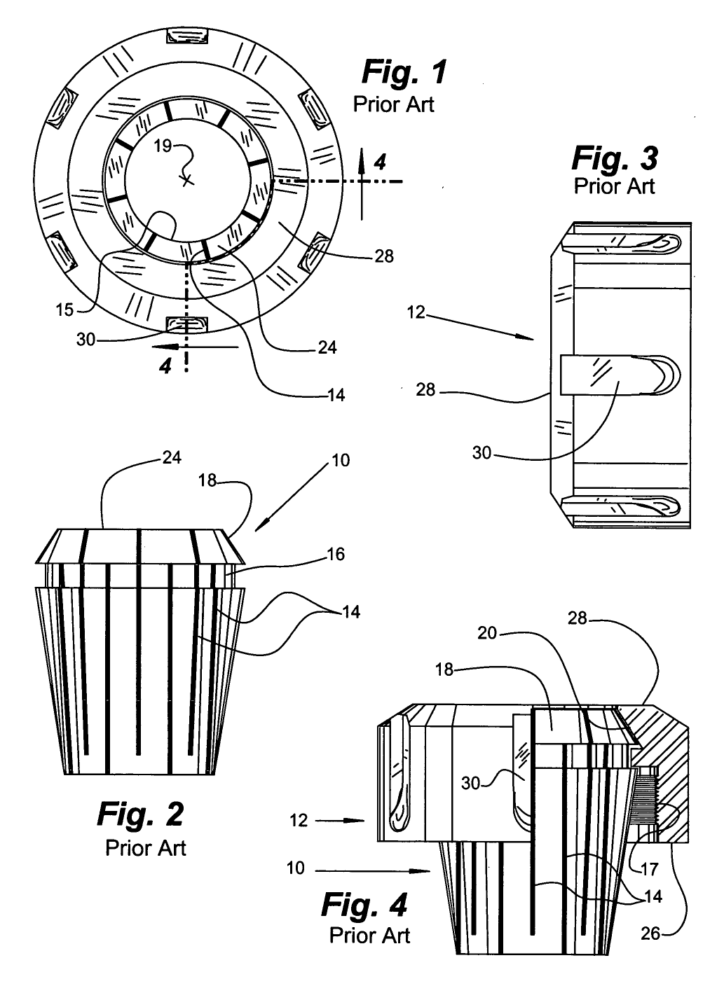

Referring particularly to the FIGS. 1-4, there is illustrated generally at 10, one form of a number of commonly available conventional split collets. Split collets function to hold or chuck a rotating tool when compressed around the shank of a tool by one of a number of commonly available conventional clamping nuts, one form of which is indicated generally at 12. Such conventional split collets are typically formed by removing thin longitudinal slices of material from the walls of the collet for most of the axial length of the collet so as to leave spaces 14. The collet is made of spring steel, or the like. The collet 10 is thus capable of expanding and contracting radially under the urging of clamping nut 12. Collet 10 is assembled to clamping nut 12 by forcing the nut over the end 24 of collet 10 until conical surface of 18 of collet 10 engages the mating conical surface 20 of clamping nut 12. The collet and nut are held in assembled relationship by the engagement of a ring in the nut with circumferential groove 16 of collet 10. A tool chucked in the collet chuck assembly typically projects axially outwardly from end 24 of clamping nut 12. Thread 17 of clamping nut 12 is threadeably engaged with a threaded tool holder (not shown). The central bore 15 of the collet 10 is expanded to receive the shank of a tool when clamping nut 12 is threadably loosened from a tool holder. The axis of rotation of the assembly is illustrated at 19. Longitudinally extending grooves of which 30 is typical are provided in the external surface of nut 12 to permit engaging the nut with a suitable spanner. The rear end 26 of nut 12 is generally opposed to front end 24 and is adjacent a tool holder.

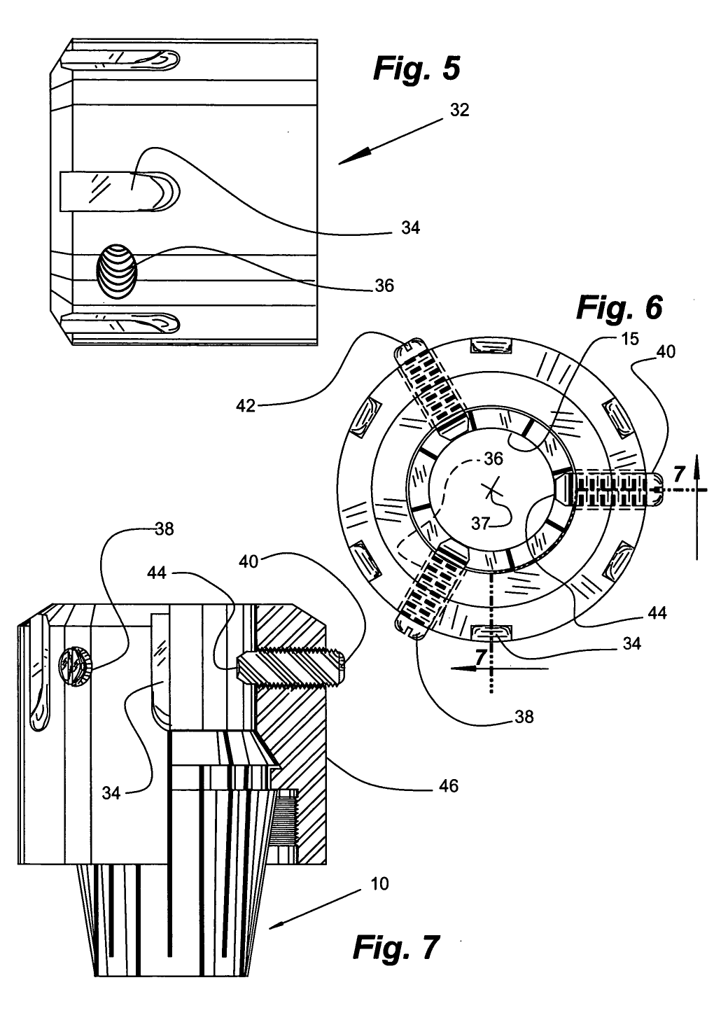

With particular reference to FIGS. 5, 6, 7, and 8, there is illustrated generally at 32 a clamping nut that also functions, according to the present invention, as a centering collar. The body 46 of the nut is extended for a sufficient axial distance beyond the end of collet 10 to provide a collar portion for mounting radially adjustable elements in the form of set screws 38, 40 and 42. The radially adjustable elements, in the embodiment chosen for illustration, are threadably mounted in threaded bores in the collar portion of body 46. Threaded bore 36 is typical. The radially adjustable set screws function as centering screws.

The rotational axis of the assembly is located at 37. The radially inner ends of set screws 38, 40, and 42 are located in substantially the same adjustment circle on the surface of the tool. This adjustment circle is generally centered on rotational axis 37, and is generally approximately concentric with and spaced axially outwardly from the bore of the collet member. These set screws are spaced approximately equally around this adjustment circle, and project generally radially towards rotational axis 37. When the axes of the set screws define a plane, the ends of the set screws meet the surface of the tool at about 90 degrees. If desired, the adjusting elements can be mounted so that their longitudinal axes define one or more cones with the tip of the cones generally centered on the rotational axis of the assembly. This permits the radial adjusting force to be applied at a contact angle of other than 90 degrees to the surface of the tool. The radially inner ends of the set screws can be shaped to provide a line of contact or a point contact between the surface of the tool and the ends of the adjusting elements. Also, the force applied can be in the nature of a wedging action when the longitudinal axis of the set screw extends at an angle to the axis of rotation. This is desirable in some circumstances. Angles of as much as 60 degrees or more can be employed, if desired. A combination of conical and planer mounting forms can be employed for the adjusting set screws, if desired, particularly if more than four set screws are used in a set.

Set screws 38, 40, and 42 are shown for purposes of illustration as projecting radially outwardly from the outer circumference of body 46. The radially adjustable elements typically do not project beyond the outer circumference of the body 46 in use. This is for reasons of safety and balance, and to avoid interference with the engagement of a spanner in slots 34 for the purpose of threadably rotating the clamping nut. The ends 44 of the radially adjustable set screws are preferably slightly concave to provide a better engagement with the shank of a tool received in bore 15.

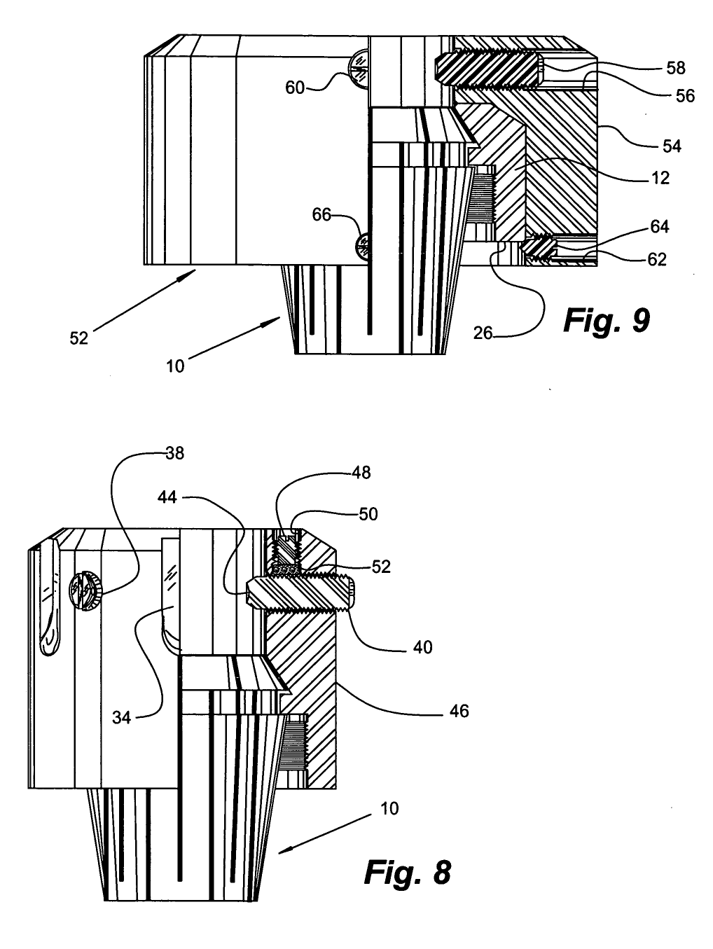

Because the radially adjustable element preferably bear directly against the surface of a cutting tool at a location axially outwardly from the shank portion that is gripped in the collet member, they are subject to substantial shock and vibration. To lock them in a desired radial position they are preferably associated with locking elements. An embodiment of a locking element is illustrated in FIG. 8. The locking element in this embodiment is in the form of a set screw 48 mounted in threaded bore 50 in the axially outer end of body 46. A thread protecting pad (typically brass or hard plastic) is positioned between the end of set screw 48 and the threads on the cylindrical surface of radially adjustable set screw 40.

In use, set screw 40 is threadably adjusted to bring the cutting tool into a desired alignment with the rotational axis 37 of the collet chuck assembly. The locking set screw 48 is threadably advanced to jam the thread protecting pad 52 into the thread of the radially adjustable set screw 40. This prevents the set screw 40 from rotating. Set screw 40 is released by backing off the locking set screw 48 so that the force on the thread protecting pad 52 is released.

With particular reference to FIG. 9, a centering collar in the form of a centering bonnet 52 is mounted over the conventional collet chuck assembly illustrated in FIGS. 1 and 4. The conventional collet chuck assembly is not modified. The centering function is provided by the bonnet 52. The body 54 of centering bonnet 52 fits snugly over and generally conforms to the periphery of clamping nut 12. Body 54 can be provided with splines (not shown) that fit into the longitudinally extending grooves 30 of clamping nut 12 as the bonnet 52 is slipped axially over the clamping nut 12. A mounting screw 64 is threadably received in threaded bore 62 in the axially lower skirt of body 54. In the embodiment chosen for illustration, several mounting set screws, of which 64 and 66 are typical, are circumferentially distributed around the skirt of the body 54 for the purpose of securely engaging the edge of the skirt of clamping nut 12 adjacent end face 26. Radially adjustable elements, of which 58 and 60 are typical, are provided for the purpose of axially aligning a tool that is mounted in the collet chuck assembly. In the embodiment chosen for purposes of illustration, the radially adjustable elements are in the form of set screws threadably mounted in threaded bores, of which 56 is typical. Suitable locking elements (not shown) can be provided in any form that may be desired.

Set screws provide a convenient form of radially adjustable elements because threaded bores to receive them can be formed quickly, easily, and accurately in separate centering collar members and in centering collar members that are a part of a clamping nut element. Set screws are very simple and reliable, and function with a minimum number of parts and mounting operations.

Other forms of radially adjustable elements can be employed according to the present invention, if desired. For example, wedging elements can be incrementally and selectively forced into engagement with a tool shank. Generally, such wedging elements are slidably mounted in a channel or groove in the centering collar member and are incrementally advanced or withdrawn under the urging of a threaded element. Other like radially adjustable elements can be employed if desired. Likewise, locking set screws are conveniently used because it is easy and simple to mount them, and they are very reliable. Other locking systems can be employed, if desired. For example, self locking nuts or inserts of various designs can be used. Also, jam screws, jam nuts, or the like can be employed.

The radially adjustable elements are typically arranged in generally equally spaced circumferential arrays around the rotational axis of a collet chuck assembly. The individual elements in a set of such elements are independently adjustable, and each set includes at least three individual elements. The elements bear on a tool at a location between the tip of the tool and the axially outer end of the collet member. The shank portion of the tool is received in the collet. For purposes of this patent it is intended that the shank be considered to be that part of the tool that is axially rearward of the axially outer end of the collet. Any part of the tool that projects axially outwardly of the collet is not considered to be part of the shank. Preferably, the elements are arrayed around approximately a common adjusting circle centered on the rotational axis of the assembly. It has been found that by locating this adjusting circle between the tip of the tool and the axially outer end of the collet member the desired precision adjustment can be achieved. It is generally not necessary to locate individual elements of the adjusting array axially of one another along the axis of rotation. Such axial location of adjusting elements substantially increases the length and complexity of the centering collar member, the time and degree of skill required to achieve the desired adjustment, and the cost of the assembly.

Selective adjustment of the adjusting elements causes the tip of the tool to be deflected slightly towards a desired alignment with the axis of rotation of the collet chuck assembly. Since the tool is generally first clamped into the assembly by fully tightening the clamping nut, the amount that the tip can be deflected is relatively small, typically less than about 0.002 inches. This is sufficient for many precision machining operations.

Many different forms of collet chuck assemblies are commercially available. The present invention is generally applicable for use with all of them. The location of the adjusting circle between the tip of the tool and the axially outer end of the collet removes the adjusting elements and associated members from interference with the collet and clamping nut, regardless of their forms. In general, a centering collar, whether integral with a clamping nut or separate from the nut, should be configured to mate closely with the particular form of collet-nut assembly to which it is to be applied.

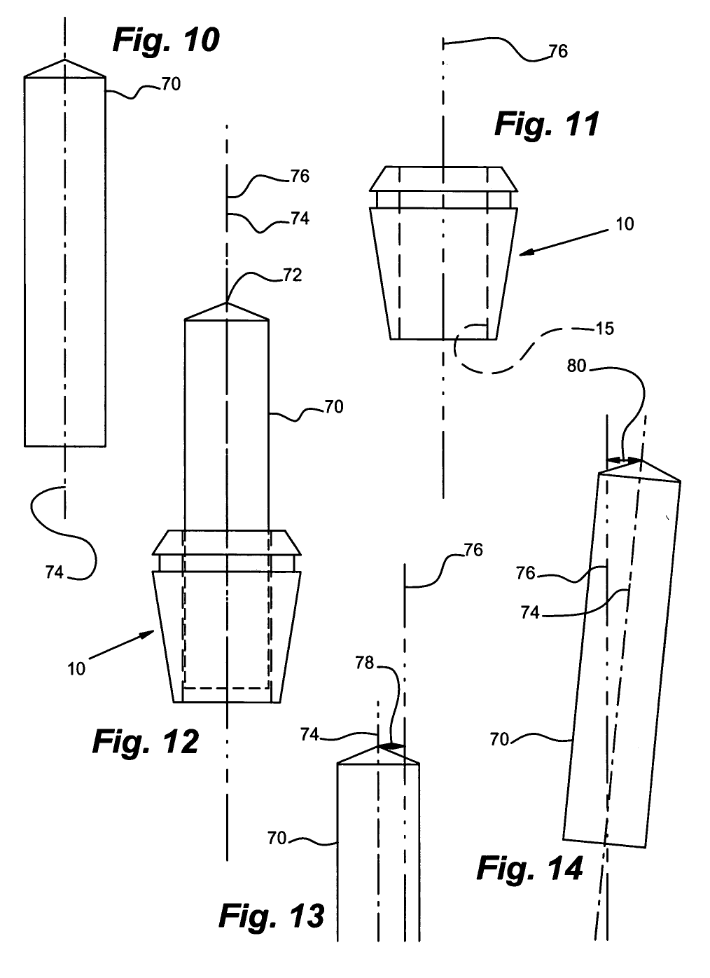

With particular reference to FIGS. 10 through 14, the alignment problems, the solution to which the present invention is addressed, are diagrammatically illustrated. A tool 70 includes a tip 72 and a longitudinal axis 74. A split collet 10 is illustrated with axis of rotation 76. When the tool 70 is assembled with its shank clamped in the bore of split collet 10 and the longitudinal axis 74 of the tool exactly congruent with the axis of rotation 76 of the assembly, as shown in FIG. 12, there is no need for any correction. When the two axes are offset laterally by an offset distance 78, the tip 72 will define a circle as the tool rotates (see FIG. 13). The circle defined by the tip 72 will have a radius equal to offset distance 78. Likewise, when the two axes are not angularly aligned tip 72 will define a circle having a radius equal to distance 80 (see FIG. 14). The magnitude of offsets 78 and 80 are greatly enlarged for ease of illustration. Frequently, both types of misalignment are found in one tool setup. Application of radial adjusting force directly to the tool generally in an adjusting circle between the tool tip and the collet member, according to the present invention, will bring the tip to the desired position relative to the axis of rotation regardless of the type of misalignment.

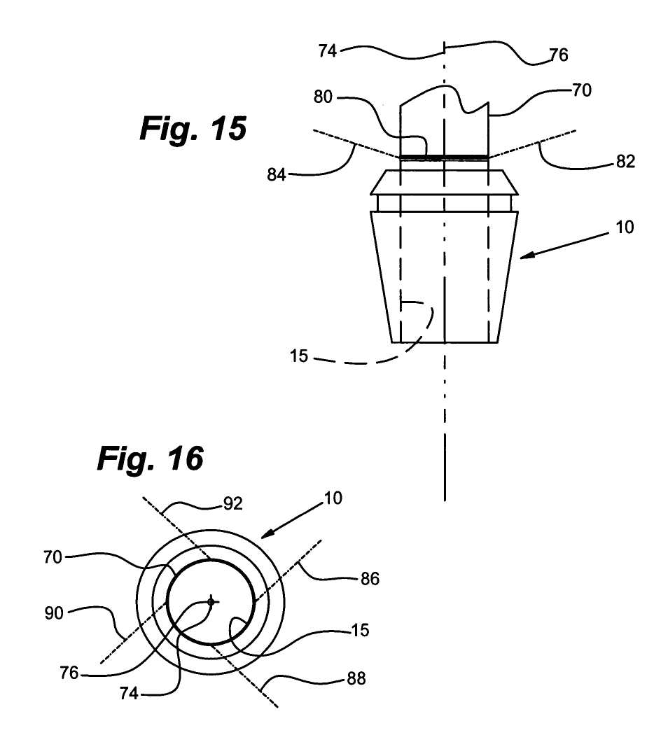

With particular reference to FIGS. 15 and 16, the longitudinal axes 82, and 84, respectively of two of the assembly's radially adjustable elements illustrate generally those embodiments of the present invention where such longitudinal axes intersect the axis of rotation 76 at an angle of other than 90 degrees (FIG. 15), or contact the tool generally tangentially (FIG. 16). Taken together these adjusting axes define a cone, the tip of which is on the axis of rotation 76. The adjusting elements associated with axes 82 and 84 bear directly against the tool 70 at generally equally spaced locations around the adjusting circle 80. The adjusting element axes 86, 88, 90, and 92 can configured to generally define either a plane or a frustum of a cone as may be desired. The adjusting elements that are associated with axes 86, 88, 90, and 92 bear directly on the outer surface of tool 70 from generally tangential directions around the tool at a location between the shank and the tip of the tool. The axes illustrated in FIG. 16 are not completely tangential to the tool (although they could be), but they do not meet at a common point on the axis of rotation and they do not intersect the axis of rotation. FIG. 16 is generally illustrative of those embodiments of the present invention wherein the longitudinal axes of the radially adjusting element do not intersect the axis of rotation of the collet chuck assembly. Such embodiments are described and defined herein as having generally tangentially mounted radially adjusting elements. Even though the axes extend at an angle or generally tangentially, the adjusting force is considered to be applied radially to the tool at generally the adjusting circle. The term “radially adjustable elements” as described and defined herein is intended to include such angled and generally tangentially mounted elements. Some wedging action results from such an angled application of the force generated by the respective adjusting elements. It is also possible in some configurations to advantageously increase the area or nature of the contact between the adjusting element and the tool by canting these axes into an angled or tangential, or a combined angled and tangential configuration.

With particular reference to FIG. 17, there is illustrated an embodiment similar to that of FIG. 7 wherein the nose of the clamping nut 98 is extended to form a centering collar. A set of three radially adjustable elements in the form of centering screws, of which 94 and 100 are typical, are threadably mounted in the centering collar portion of clamping nut 98 spaced approximately 120 degrees apart around the clamping nut 98. The radially adjustable elements also include a separate component 96 that is slidably mounted in clamping nut 98 so that it is forced by the threaded advancement of centering screw 94 into engagement with a tool. The embodiments of which this is illustrative are particularly useful where it is desired to avoid the rotation of a screw end in engagement with a tool, or it is necessary to avoid engaging the tool with a material that has the characteristics (hardness or the like) necessary for use in a centering screw. For example, it may be desired to contact the tool with a harder or softer material than is provided by the centering screw.

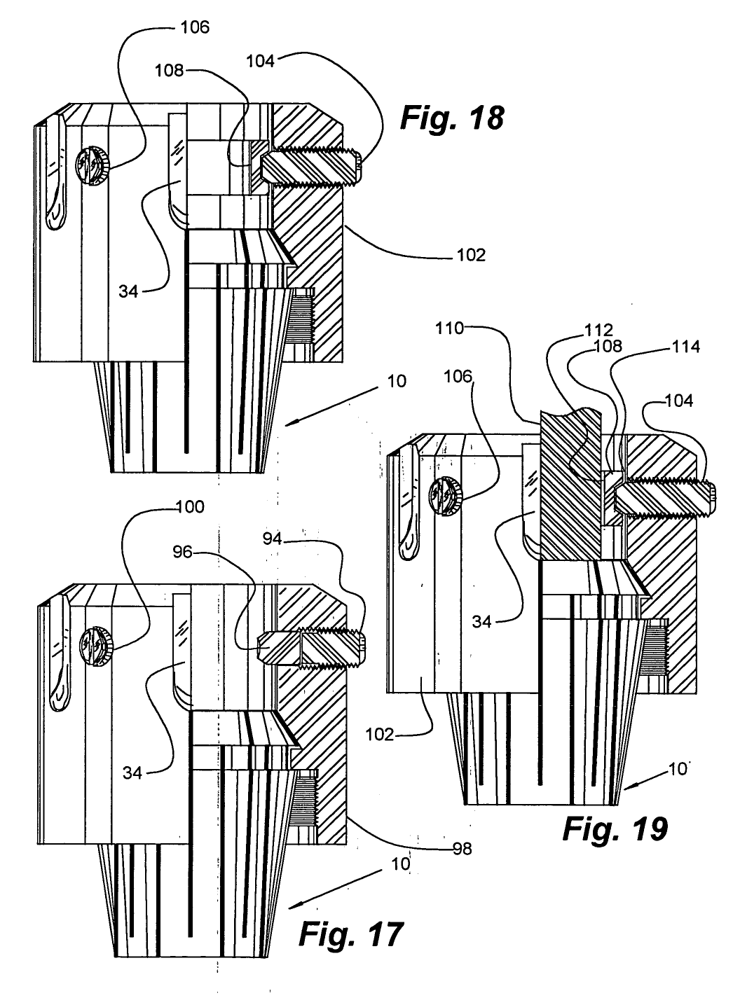

With particular reference to FIGS. 18 and 19, there is shown an embodiment that is illustrative of those embodiments wherein design considerations dictate that a large contact area be provided between the tool and the radially adjustable elements. A loosely fitting ring 108 is retained in the clamping nut 102 by the loose engagement of a groove on the outer circumference of the ring 108 with the conforming nose portions of a set of centering screws, of which 104 and 106 are typical. There is substantial clearance 112 between the tool 110 and the inside diameter of ring 108. Likewise, there is a substantial clearance 114 between the outside diameter of ring 108 and inside diameter of clamping nut 102. The clearances 112 and 114 are proportioned so that even if a tool is deflected to the maximum, the ring will not touch the inside wall of the clamping nut 102 on the opposed side. The ring 108 is not distorted by the centering force. It simply moves within the clearance provided under the urging of one or two of the centering screws. The radially adjusting force is applied between the shank of the tool (within the split collet 10) and the tip of the tool. Attempts to apply radially adjusting force to the collet itself have been found to be ineffective in deflecting the tip of the tool towards a desired location. Having a broader area of contact sometimes provides greater stability to the tool so it retains its position better. Also, if a tool is particularly brittle, a broad area of contact can protect it from shattering when subjected to shock and vibration during use.

What have been described are preferred embodiments in which modifications and changes may be made without departing from the spirit and scope of the accompanying claims. Many modifications and variations of the present invention are possible in light of the above teachings. It is therefore to be understood that, within the scope of the appended claims, the invention may be practiced otherwise than as specifically described.

What is claimed is:

1. A collet chuck assembly including an axis of rotation and at least a collet member and a clamping nut element wherein said clamping nut element is adapted to squeeze said collet member radially inwardly to grip a shank of a tool received axially in said collet member, said tool having a longitudinal axis and a tip, said tip being at a location axially remote from said shank, said collet chuck assembly including at least three generally radially adjustable elements spaced generally circumferentially from one another around said axis of rotation and adapted to being in adjustably engaging relationship with said tool between said collet member and said tip, said generally radially adjustable elements being adapted to adjusting the location of said tip relative to said axis of rotation.

2. A collet chuck assembly of claim 1 wherein said generally radially adjustable elements are threadably mounted in said clamping nut element.

3. A collet chuck assembly of claim 1 wherein said generally radially adjustable elements are threadably mounted in a centering collar member, said centering collar member being mounted to at least said clamping nut element.

4. A collet chuck assembly of claim 1 wherein said collet chuck assembly includes at least four said generally radially adjustable elements.

5. A collet chuck assembly of claim 1 wherein said generally radially adjustable elements are adapted to deflecting said tool to bring said longitudinal axis into alignment with said axes of rotation at least at approximately said tip.

6. A collet chuck assembly of claim 1 wherein said generally radially adjustable elements are adapted to being locked in predetermined radial positions by locking members.

7. A collet chuck assembly of claim 1 wherein said generally radially adjustable elements are threadably mounted in a centering bonnet member, said centering bonnet member being mounted over said clamping nut element.

8. A collet chuck assembly including an axis of rotation and at least a collet member and a clamping nut element wherein said clamping nut element is adapted to squeeze said collet member radially inwardly to grip a shank of a tool received axially in said collet member, said tool having a longitudinal axis and a tip, said tip being at a location axially remote from said shank, said collet chuck assembly including at least three generally radially adjustable elements spaced generally circumferentially from one another around and adapted to being in adjustably engaging relationship with said tool between said collet member and said tip, said generally radially adjustable elements being adapted to adjusting the location of said tip relative to said axis of rotation, said generally radially adjustable elements being mounted in said clamping nut element.

9. A collet chuck assembly including an axis of rotation and at least a collet member and a clamping nut element wherein said clamping nut element is adapted to squeeze said collet member radially inwardly to grip a shank of a tool received axially in said collet member, said tool having a longitudinal axis and a tip, said tip being at a location axially remote from said shank, said collet chuck assembly including at least three generally radially adjustable elements spaced generally circumferentially from one another around and adapted to being in adjustably engaging relationship with said tool between said collet member and said tip, said generally radially adjustable elements being adapted to adjusting the location of said tip relative to said axis of rotation, said generally radially adjustable elements being mounted in a centering collar member, said centering collar member being mounted at least in part to said clamping nut element.

10. A collet chuck assembly including an axis of rotation and at least a collet member and a clamping nut element wherein said clamping nut element is adapted to squeeze said collet member radially inwardly to grip a shank of a tool received axially in said collet member, said tool having a longitudinal axis and a tip, said tip being at a location axially remote from said shank, said collet chuck assembly including at least three generally radially adjustable elements spaced generally circumferentially and equa-distant from one another around said axis of rotation and adapted to being in independently adjustably engaging relationship with said tool between said collet member and said tip, said generally radially adjustable elements being adapted to adjusting the location of said tip relative to said axis of rotation, said generally radially adjustable elements being associated with a locking element, said locking elements being adapted to locking said generally radially adjustable elements in a predetermined position relative to said shank.

11. A collet chuck assembly including an axis of rotation and at least a collet member and a clamping nut element wherein said clamping nut element is adapted to squeeze said collet member radially inwardly to grip a shank of a tool received axially in said collet member, said tool having a longitudinal axis and a tip, said tip being at a location axially remote from said shank, said collet chuck assembly including at least three threadably adjustable elements spaced generally circumferentially and equa-distant from one another around said axis of rotation and adapted to being in radially adjustably engaging relationship with said tool generally in an adjusting circle between said collet member and said tip, said threadably adjustable elements being adapted to adjusting the location of said tip relative to said axis of rotation.

12. A collet chuck assembly of claim 11 wherein said threadably adjustable elements have radially extending longitudinal axes and said radially extending axes together generally define a cone, said cone having a tip located generally on said axis of rotation.

13. A collet chuck assembly of claim 11 wherein said threadably adjustable elements have generally tangentially extending longitudinal axes.

14. A collet chuck assembly of claim 13 wherein said longitudinal axes generally define a plane.

15. A collet chuck assembly of claim 13 wherein said longitudinal axes generally define a frustum of a cone.

16. A collet chuck assembly including an axis of rotation and at least a collet member and a clamping nut element wherein said clamping nut element is adapted to squeeze said collet member radially inwardly to grip a shank of a tool received axially in said collet member, said tool having a longitudinal axis and a tip, said tip being at a location axially remote from said shank, said collet chuck assembly including at least three generally radially adjustable elements spaced generally circumferentially from one another around said axis of rotation and adapted to being in adjustably engaging relationship with said tool between said collet member and said tip, said generally radially adjustable elements including at least two parts and being adapted to adjusting the location of said tip relative to said axis of rotation.
